(19) United States
(12) Patent Application Publication
(10) Pub. No.: US 2025/0103691 A1
(43) Pub. Date: Mar. 27, 2025

(54) INFORMATION PROCESSING APPARATUS, DISPLAY CONTROL METHOD, AND RECORDING MEDIUM

(71) Applicant: NEC Corporation, Tokyo (JP)

(72) Inventors: Akio YOSHIOKA, Tokyo (JP); Masahiro Iwadare, Tokyo (JP); Masahiro Serizawa, Tokyo (JP); Shinnosuke Nishimoto, Tokyo (JP)

(73) Assignee: NEC Corporation, Tokyo (JP)

(21) Appl. No.: 18/883,137

(22) Filed: Sep. 12, 2024

(30) Foreign Application Priority Data
Sep. 21, 2023 (JP) 2023-156453

(51) Int. Cl. G06F 21/31

(52) U.S. Cl. CPC G06F 21/316; G06F 2221/2133

(57) ABSTRACT

Whether an object is acting under control of a human or via artificial intelligence is made identifiable. An information processing apparatus includes: a judging unit 101 for judging whether an object displayed as an agent of action is acting under control of a human or via artificial intelligence; and a display control unit 102 for causing a display manner of the object to be in accordance with the result of the judgment made by the judging unit 101.

### CROSS REFERENCE TO RELATED APPLICATIONS

This application is based upon and claims the benefit of priority from Japanese Patent Application No. 2023-156453 filed on Sep. 21, 2023, the disclosure of which is incorporated herein in its entirety by reference.

### TECHNICAL FIELD

The present disclosure relates to an information processing apparatus, a display control method, and a recording medium.

### BACKGROUND ART

Techniques related to the metaverse are receiving attention. Examples of techniques related to the metaverse include the information management apparatus disclosed in Patent Literature 1. In a case where a three-dimensional virtual space is used in business, the information management apparatus disclosed in Patent Literature 1 collects and analyzes various kinds of information related to avatars which are alter egos of users, to make the information usable in marketing.

### CITATION LIST

### Patent Literature

### [Patent Literature 1]

Japanese Patent Application Publication Tokukai No. 2011-216073

### SUMMARY OF INVENTION

### Technical Problem

In the information management apparatus disclosed in Patent Literature 1, a single avatar is associated with a single user. That is, in the information management apparatus, the behavior of the avatar in a three-dimensional virtual space is taken as the behavior of the user associated with the avatar, to perform the analysis. However, in these days, the evolution of artificial intelligence has made it possible to cause an avatar to act as if a human controls the avatar. If the behavior of the avatar acting via artificial intelligence is taken as the behavior of the user, the validity of the analysis result would end up destroyed.

Further, besides the marketing conducted with use of avatars in a three-dimensional virtual space as disclosed in Patent Literature 1, there are needs for identification of whether a displayed object is acting under control of a human or via artificial intelligence.

An example object of the present disclosure is to provide a technique for making identifiable whether a displayed object is acting under control of a human or via artificial intelligence.

### Solution to Problem

An information processing apparatus in accordance with an example aspect of the present disclosure includes at least one processor, and the at least one processor carries out: a judging process of judging whether an object displayed as an agent of action is acting under control of a human or via artificial intelligence; and a display control process of causing a display manner of the object to be in accordance with a judgment result obtained by the judging process.

A display control method in accordance with an example aspect of the present disclosure includes: at least one processor judging whether an object displayed as an agent of action is acting under control of a human or via artificial intelligence; and the at least one processor causing a display manner of the object to be in accordance with a judgment result obtained in the judging.

A recording medium in accordance with an example aspect of the present disclosure is a computer-readable non-transitory recording medium having recorded thereon a display control program for causing a computer to carry out: a judging process of judging whether an object displayed as an agent of action is acting under control of a human or via artificial intelligence; and a display control process of causing a display manner of the object to be in accordance with a judgment result obtained in the judging process.

### Advantageous Effects of Invention

An example aspect of the present disclosure provides an example advantage of making it possible to provide a technique for making identifiable whether a displayed object is acting under control of a human or via artificial intelligence.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of a display control method in accordance with the present disclosure.

FIG. 3 is a representation of a configuration of a display control system in accordance with the present disclosure.

FIG. 4 is a block diagram illustrating a configuration of another information processing apparatus in accordance with the present disclosure.

FIG. 5 is a representation of example display manners of an avatar.

FIG. 6 is a representation of an example in which whether an avatar is acting under control of a human or via AI is judged based on a result of causing a predetermined task to be carried out.

FIG. 7 is a flowchart illustrating a flow of processes carried out by the information processing apparatus illustrated in FIG. 4.

FIG. 8 is a representation of an example in which the information processing apparatus illustrated in FIG. 4 is applied to chat screen display.

FIG. 9 is a block diagram illustrating a configuration of a computer which functions as the information processing apparatuses in accordance with the present disclosure.

### DESCRIPTION OF EMBODIMENTS

The following description will discuss example embodiments of the present invention. However, the present invention is not limited to the example embodiments described below, but can be altered by a skilled person in the art within the scope of the claims. For example, any embodiment derived by appropriately combining technical means adopted in differing example embodiments described below can be within the scope of the present invention. Further, any embodiment derived by appropriately omitting some of the technical means adopted in differing example embodiments described below can be within the scope of the present invention. Furthermore, the advantage mentioned in each of the example embodiments described below is an example advantage expected in that example embodiment, and does not define the extension of the present invention. That is, any embodiment which does not provide the example advantages mentioned in the example embodiments described below can also be within the scope of the present invention.

### First Example Embodiment

The following description will discuss a first example embodiment, which is an example embodiment of the present invention, in detail with reference to the drawings. The present example embodiment is basic to each of the example embodiments which will be described later. It should be noted that the scope of application of each of the technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings referred to for the description of the present example embodiment can be adopted in another example embodiment included in the present disclosure, to the extent of constituting no specific technical obstacle.

### (Configuration of Information Processing Apparatus 1)

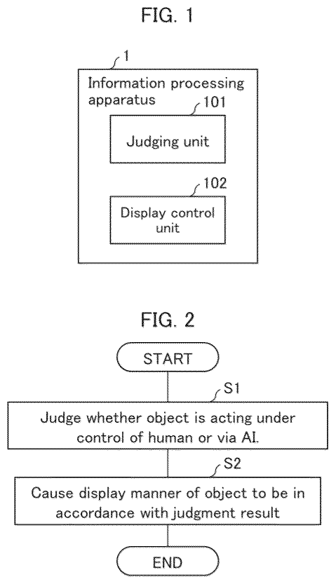

A configuration of an information processing apparatus 1 will be described below with reference to FIG. 1. FIG. 1 is a block diagram illustrating a configuration of the information processing apparatus 1. The information processing apparatus 1 includes a judging unit 101 and a display control unit 102, as illustrated in FIG. 1.

The judging unit 101 judges whether an object displayed as the agent of action is acting under control of a human or via artificial intelligence. In this context, the “action” can include behaviors of the object in general. Examples of the “action” include a movement on a screen or in a virtual space, a change in posture or orientation, a change in facial expression, and utterance. Further, the “utterance” includes displaying, in the form of a speech balloon or the like, text which indicates the content of utterance, in addition to outputting voice. Furthermore, the “object” only needs to be recognizable as the agent of action, and may be a simulant of a human, an animal, etc., or may be a shape or a combination of shapes.

The phrase “be acting via artificial intelligence” means that an action is partially or wholly controlled via AI, or the content of an action is determined by artificial intelligence. In this context, the “artificial intelligence” means the technology in which functions such as inference and decision are artificially implemented. For example, using a trained model generated by machine learning, to cause an object to act or to decide the content of an action (e.g. the content of utterance) of an object falls under causing an object to act via artificial intelligence. In the following description, artificial intelligence is also referred to as AI.

The display control unit 102 causes the display manner of the object to be in accordance with the result of the judgment made by the judging unit 101. The display manner only needs to be a manner which enables recognition of whether the object is acting under control of a human or via AI. A display on which the object is displayed is any display, and may be included in the information processing apparatus 1, or may be included in another apparatus.

### (Example Advantage of Information Processing Apparatus 1)

As above, the information processing apparatus 1 includes: a judging unit 101 for judging whether an object displayed as the agent of action is acting under control of a human or via AI; and a display control unit 102 for causing a display manner of the object to be in accordance with the result of the judgment made by the judging unit 101. The information processing apparatus 1 therefore provides an example advantage of making it possible to make identifiable whether a displayed object is acting under control of a human or via AI.

### (Display Control Program)

The functions of the information processing apparatus 1 can be implemented via a program. A display control program in accordance with the present example embodiment causes a computer to function as: a judging means for judging whether an object displayed as the agent of action is acting under control of a human or via AI; and a display control means for causing a display manner of the object to be in accordance with the result of the judgment made by the judging means. The display control program in accordance with the present example embodiment therefore provides an example advantage of making it possible to make identifiable whether an object is acting under control of a human or via AI.

### (Flow of Display Control Method)

A flow of a display control method will be described below with reference to FIG. 2. FIG. 2 is a flowchart illustrating a flow of the display control method. It should be noted that each of the steps of this display control method may be carried out by a processor included in the information processing apparatus 1, or may be carried out by a processor included in another apparatus. Alternatively, the respective steps may be carried out by processors provided in different apparatuses.

In S1 (judging process), at least one processor judges whether an object displayed as the agent of action is acting under control of a human or via AI.

In S2 (display control process), the at least one processor causes the display manner of the object to be in accordance with the judgment result obtained in S1.

### (Example Advantage of Display Control Method)

As above, the display control method includes: a judging process of at least one processor judging whether an object displayed as the agent of action is acting under control of a human or via artificial intelligence; and a display control process of the at least one processor causing a display manner of the object to be in accordance with a judgment result obtained in the judging process. The display control method therefore provides an example advantage of making it possible to make identifiable whether a displayed object is acting under control of a human or via artificial intelligence.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. It should be noted that the scope of application of each of the technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings referred to for the description of the present example embodiment can be adopted in another example embodiment included in the present disclosure, to the extent of constituting no specific technical obstacle.

### (Configuration of Display Control System 5)

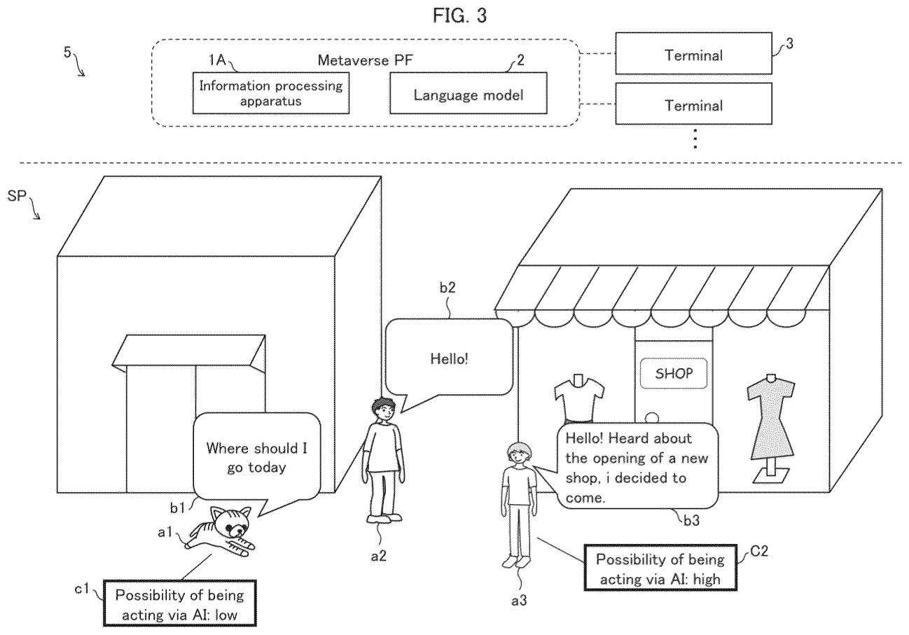

The configuration of a display control system 5 will be described below with reference to FIG. 3. FIG. 3 is a representation of a configuration of the display control system 5. The display control system 5 has the function of controlling the display of an object in a three-dimensional virtual space. In FIG. 3, a virtual space SP is also illustrated which is an example of a three-dimensional virtual space which is subject to display control performed by the display control system 5.

The display control system 5 includes an information processing apparatus 1A, a language model 2, and a terminal 3, as illustrated. The information processing apparatus 1A and the language model 2 are components of a metaverse platform (PF) on which it is possible for a user to cause an avatar of the user to perform various actions in a three-dimensional virtual space. The metaverse PF may include various components in addition to the illustrated apparatuses. Further, each of the numbers of the information processing apparatuses 1A, the language models, and the terminals 3 included in the display control system 5 is any number, and is not limited to the illustrated example.

The information processing apparatus 1A judges whether an avatar which is the object displayed as the agent of various actions in the virtual space SP is acting under control of a human or via artificial intelligence, and causes the display manner of the avatar to be in accordance with a result of the judgment. This provides an example advantage of making it possible to make identifiable whether an avatar displayed in the virtual space SP is acting under control of a human or via artificial intelligence.

For example, in the virtual space SP illustrated in FIG. 3, two shops are disposed, and three avatars which are a1 to a3 are also disposed. Among the avatars, the avatar a2 is the avatar of a user (hereinafter, referred to as a target user) who has the virtual space SP displayed on the terminal 3 of the user. The avatars a1 and a3 are of other users.

The target user is capable of displaying, on the terminal 3, an image in the virtual space SP. The image in the virtual space SP is generated through at least one selected from the group consisting of the metaverse PF and software running on the terminal 3. The target user is also capable of operating the terminal 3 to move the avatar a2 and to cause the avatar a2 to utter, in the virtual space SP. In the example of FIG. 3, a speech balloon b2 is displayed so as to be associated with the avatar a2. In this manner, text inputted by the user is displayed in the speech balloon b2 as an utterance produced by the avatar a2.

In the example of FIG. 3, a speech balloon b1, which represents an utterance produced by the avatar a1, is displayed so as to be associated with the avatar a1. Similarly, a speech balloon b3, which represents an utterance produced by the avatar a3, is displayed so as to be associated with the avatar a3. Conventionally, it has been difficult for a target user to recognize whether such an utterance produced by another avatar is performed under control of a human or via AI.

To address this, in the display control system 5, the information processing apparatus 1A judges whether the avatars a1 and a3 are acting under control of a human or via AI, and causes the display manners of the avatars a1 and a3 to be in accordance with the judgment results. Specifically, the avatar a1 is displayed so as to be associated with judgment result information c1 which indicates that the possibility that the avatar a1 is acting via AI is low (i.e., the possibility that the avatar a1 is acting under control of a human is high). Specifically, the avatar a3 is displayed so as to be associated with judgment result information c2 which indicates that the possibility that the avatar a3 is acting via AI is high (i.e., the possibility that the avatar a3 is acting under control of a human is low). Such displays enable the target user to bring, to an end, the conversation with the avatar a3, which has a low possibility of being acting under control of a human, and then talk to the avatar a1, which has a high possibility of being acting under control of a human.

The avatars are examples of the object to be displayed as the agent of action. What is subject to the display control carried out by the information processing apparatus 1A only needs to be an object which is displayed as the agent of action. Thus, the “avatar” in the description above and below is interchangeable with any “object”. Further, in the present example embodiment, an example in which whether the utterance produced by an avatar is performed under control of a human or via AI is judged is described. However, the information processing apparatus 1A is capable of making a judgment regarding any action other than utterance, on whether the action is performed under control of a human or via AI.

The language model 2 is constructed by machine learning of the arrangement of the components (such as words) of a sentence expressed in a natural language and the arrangement of sentences in text. It is possible for a user of the metaverse PF to use the language model 2 to cause the avatar of the user to automatically utter. This is a convenient function in a case where, for example, the user suspends the operation of the avatar. Note that the user may use the language model outside the metaverse PF to cause the avatar to utter. The avatar which utters through the use of a language model is an avatar which utters via AI.

The terminal 3 is used by a user of the metaverse PF so that the user uses the metaverse PF. The terminal 3 may include, for example, a displaying unit on which the virtual space SP is displayed, an input unit for accepting an operation for moving an avatar in the virtual space SP and an operation for causing an avatar to utter, and a communicating unit for communicating with the information processing apparatus 1A. For example, the terminal 3 may be a portable apparatus such as a smartphone or a tablet, or may be a stationary apparatus such as a desktop personal computer (PC).

### (Configuration of Information Processing Apparatus 1A)

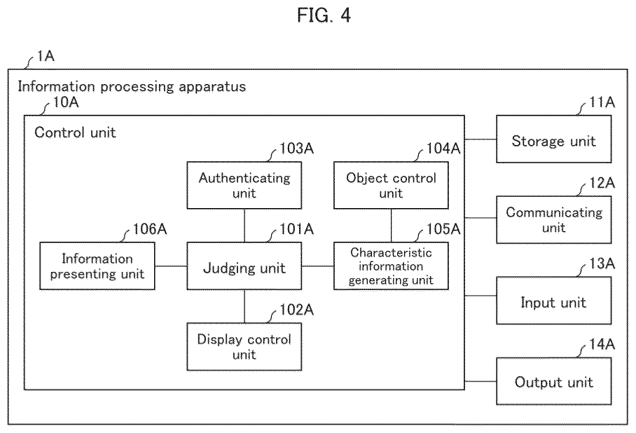

A configuration of an information processing apparatus 1A will be described below with reference to FIG. 4. FIG. 4 is a block diagram illustrating a configuration of the information processing apparatus 1A. As illustrated, the information processing apparatus 1A includes: a control unit 10A for performing overall control of the units of the information processing apparatus 1A; and a storage unit 11A in which various kinds of data used by the information processing apparatus 1A are stored. The information processing apparatus 1A further includes: a communicating unit 12A via which the information processing apparatus 1A communicates with another apparatus (e.g. terminal 3); an input unit 13A for accepting input of various kinds of data to the information processing apparatus 1A; and an output unit 14A via which the information processing apparatus 1A outputs various kinds of data. Furthermore, as illustrated, the control unit 10A of the information processing apparatus 1A includes a judging unit 101A, a display control unit 102A, an authenticating unit 103A, an object control unit 104A, a characteristic information generating unit 105A, and an information presenting unit 106A.

The judging unit 101A judges whether an avatar displayed as the agent of action is acting under control of a human or via AI, like the judging unit 101 of the information processing apparatus 1 of the first example embodiment. A judgment method carried out by the judging unit 101A will be described later in the sections from “Judgment method 1” to “Judgment method 4”.

The display control unit 102A causes the display manner of an avatar to be in accordance with the result of the judgment made by the judging unit 101A, like the display control unit 102 of the information processing apparatus 1 of the first example embodiment. A specific display manner will be described later in the section “Example display of object”.

The authenticating unit 103A performs authentication of a person associated with an avatar displayed in the virtual space SP, i.e., a user of the metaverse PF. For example, the authenticating unit 103A may perform authentication of a user on the basis of whether registration information registered in advance by the user to start using the metaverse PF matches input information inputted by the user. The registration information may be a password or the like, or may be biological information (e.g. finger print, finger vein, voice print, facial image, etc.). That is, the authenticating unit 103A may perform biometric authentication.

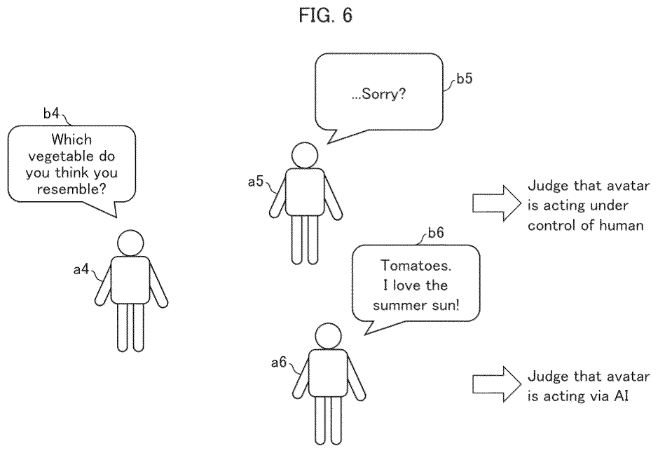

The object control unit 104A controls the action of an avatar in the virtual space SP. Although the details will be described later on the basis of FIG. 6, the object control unit 104A, for example, controls the action of any avatar so as to cause an avatar which is subject to a judgment made by the judging unit 101A to carry out a predetermined task.

The characteristic information generating unit 105A generates characteristic information which indicates a feature of the action performed by an avatar. The details of the characteristic information generating unit 105A will be described later in the section “Judgment method 1”.

The information presenting unit 106A presents predetermined information to the avatar judged, by the judging unit 101A, to be acting under control of a human. This makes it possible to efficiently cause a user who controls the avatar to recognize information. The information to be presented is not particularly limited. As an example, the information presenting unit 106A may present an advertisement for a commercial product, a service, or the like. This makes it possible to avoid unnecessarily presenting an advertisement to an avatar which is acting via AI, and efficiently present an advertisement to a human. As another example, the information presenting unit 106A may present a matter to be notified to a user. This makes it possible to avoid a situation where notification is made to an avatar controlled by AI and the matter to be notified is not transmitted to the user.

### (Example Display of Object)

As described above, the display control unit 102A causes the display manner of an avatar to be in accordance with the result of the judgment made by the judging unit 101A. This display manner only needs to enable the target user to identify whether a displayed avatar is acting under control of a human or via AI. As an example, the display control unit 102A may display the pieces of judgment result information c1 and c2 which explicitly indicate the judgment results such that the pieces of judgment result information c1 and c2 are associated with the respective avatars, as in the example of FIG. 3.

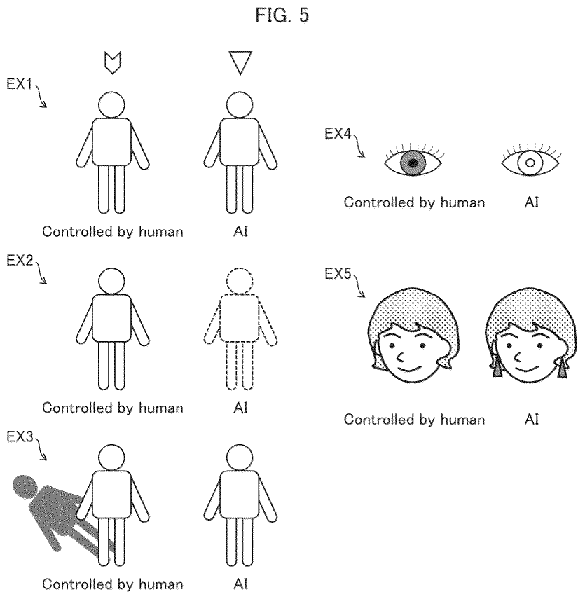

As another example, the display control unit 102A may make identifiable by the manners illustrated in FIG. 5 whether an avatar is acting under control of a human or via AI. FIG. 5 is a representation of example display manners of an avatar. Illustrated in FIG. 5 are five examples which are EX1 to EX5.

EX1 is an example in which whether an avatar is acting under control of a human or via AI is identifiable by an icon displayed so as to be associated with the avatar. That is, in EX1, the shape of an icon displayed so as to be associated with an avatar controlled by a human differs from the shape of an icon displayed so as to be associated with an avatar acting via AI. This display manner enables a user to identify whether an avatar is acting under control of a human or via AI, by checking the icon associated with the avatar.

The display control unit 102A may display the icon such that the icon is superimposed on an avatar. Further, by making the icons different from each other in color, size, etc. instead of shape, the display control unit 102A may make identifiable whether an avatar is acting under control of a human or via AI. Furthermore, with respect to either an avatar which is acting under control of a human or an avatar which is acting via AI, the display control unit 102A may display a predetermined icon and judgment result information which indicates the result of the judgment made by the judging unit 101A.

EX2 is an example in which the display manner of an outline of an avatar which is acting via AI differs from the display manner of an outline of an avatar which is acting under control of a human. Specifically, in EX2, the outline of the avatar which is acting via AI is indicated by a broken line. This allows intuitive recognition that the avatar which is acting via AI does not have substance (a user operating the avatar). In this manner, the display control unit 102A may change the display manner of an avatar judged to be acting via AI, to indicate that the avatar is acting via AI.

EX3 is an example in which as to an avatar which is acting under control of a human, the shadow of the avatar is drawn, whereas as to an avatar which is acting via AI, the shadow of the avatar is not drawn. Applying such a display manner also allows intuitive recognition that the avatar which is acting via AI does not have substance (a user operating the avatar), as in EX2.

In EX4, an eye of an avatar which is acting under control of a human and an eye of an avatar which is acting via AI are illustrated. In this example, the eyeball color differs between the avatar which is acting under control of a human and the avatar which is acting via AI. In this manner, by making different the display manner of some part of an avatar, the display control unit 102A may make identifiable whether the avatar is acting under control of a human or via AI. For example, the display control unit 102A may hide some part such as an iris or a nose of an avatar which is acting via AI. In this manner, causing the appearance of an avatar which is acting via AI to provide a user with a feeling of strangeness allows intuitive recognition that the avatar which is acting via AI does not have substance (a user operating the avatar).

EX5 is an example in which an image simulating a predetermined article is displayed so as to be associated with an avatar which is acting via AI. Specifically, in EX5, a pair of pierced earrings are displayed on the ears of the avatar which is acting via AI. In this manner, by displaying an avatar in the state of wearing a predetermined article in a virtual space, the display control unit 102A may make identifiable whether the avatar is acting under control of a human or via AI. The display control unit 102A may make identifiable whether an avatar is acting under control of a human or via AI, also by articles other than pierced earrings and earrings, such as various accessories such as necklaces, rings, and bracelets glasses, clothes, or hats.

The display control unit 102A may cause a speech balloon which indicates the utterance produced by an avatar to differ between an avatar which is acting via AI and an avatar which is acting under control of a human, in at least one selected from the group consisting of the background of the speech balloon, the color and design of the frame of the speech balloon, and the font of characters displayed in the speech balloon.

### (Judgment Method 1: Judgment Based on Characteristic of Action of Object)

As described above, the judging unit 101A judges whether an avatar is acting under control of a human or via artificial intelligence. A judgment method carried out by the judging unit 101A will be described below.

For example, the judging unit 101A may use characteristic information which indicates a characteristic of an action of an avatar, to judge whether the avatar is acting under control of a human or via AI. In this respect, whether an avatar is acting under control of a human or via AI can manifest as the difference between actions of avatars. Thus, the above configuration provides an example advantage of making it possible to obtain a valid judgment result based on an action of an avatar, which is objectively perceivable information, in addition to the example advantage provided by the information processing apparatus 1. Note that the “action of an avatar” includes any action performed by the avatar which serves as the agent of the action. Examples of the “action of an avatar” include the motion of the avatar (including the motion of a part of the body or the motion of the entire body, a change in facial expression, etc.) and the action of utterance produced by the avatar.

To cite a specific example, the characteristic information may be information which indicates the amount of time (which can be referred to as a response speed) from when an action is performed to ask an avatar which is subject to the judgment to utter to when the avatar starts to utter. This is because there is a difference between an avatar which is uttering via AI and an avatar which is acting under control of a human in the amount of time from when an action to ask for utterance is performed to when the avatar starts to utter. That is, when compared with an avatar which is acting under control of a human, an avatar which is uttering via AI tends to need a shorter time to start uttering and tends to have a smaller variation (or no variation) in the amounts of time required for starting utterance. Thus, by using the characteristic information which indicates the amount of time required for an avatar to start uttering, it is possible to obtain a valid judgment result regarding an uttering avatar, in addition to the example advantage provided by the information processing apparatus 1.

The above characteristic information is generated by the characteristic information generating unit 105A. The characteristic information generating unit 105A monitors the utterance produced by an avatar and measures the amount of time from when an action to ask for utterance is performed to when the avatar starts uttering, to generate the characteristic information which indicates such an amount of time. Note that, in a case where an avatar produces a plurality of utterances, the characteristic information generating unit 105A may generate respective pieces of characteristic information for the plurality of utterances. In this case, the judging unit 101A uses any or some of the pieces of characteristic information generated, to make the judgment. In a case where some pieces of characteristic information are used, the judging unit 101A may use a representative value (e.g. mean, variance, median, mode, maximum, minimum, or the like) of the amounts of time required for starting utterance indicated in the pieces of characteristic information. Further, the characteristic information generating unit 105A may generate a single piece of characteristic information by considering the plurality of utterances together. In this case, the characteristic information generating unit 105A may generate the characteristic information which indicates a representative value of the amounts of time required for starting utterance in the plurality of utterances.

The characteristic information only needs to indicate a characteristic of an action of an avatar, and is not limited to the above example. For example, the characteristic information may be used which indicates a time interval between actions performed by an avatar, a grammatical error in utterance, inconsistencies in expression, unnatural expression, falter, saying anew, and the numbers and frequencies of letters, typographical errors, omitted letters, etc. of text into which an utterance is converted. An avatar which is acting via AI has characteristics such as moving regularly, uttering a long sentence at a speed at which a human cannot type, and no (or few) human errors in the content of an utterance. It is therefore possible to use, as the characteristic information, the pieces of information as described above. Further, the judging unit 101A may use a plurality of pieces of characteristic information in combination, to make the judgment. This makes it possible to improve the accuracy of judgment.

### (Judgment Method 2: Judgment Based on Result of Causing Task to be Carried Out)

The information processing apparatus 1A include the object control unit 104A for causing an avatar to carry out a predetermined task. Thus, the judging unit 101A may judge, based on a result of causing the task to be carried out, whether the avatar is acting under control of a human or via AI. This provides an example advantage of making it possible to improve the accuracy of judgment, in addition to the example advantage provided by the information processing apparatus 1. Note that the task an avatar is caused to carry out only needs to be such that whether the avatar is acting under control of a human or via AI makes a difference in the result of causing the task to be carried out.

FIG. 6 is a representation of an example in which whether an avatar is acting under control of a human or via AI is judged based on a result of causing the avatar to carry out a predetermined task. In FIG. 6, three avatars which are a4 to a6 are illustrated. Among the avatars, the avatar a4 causes another avatar to carry out a predetermined task, and is controlled by the object control unit 104A. Each of the avatars a5 and a6 is subject to judgment on whether the avatar is acting under control of a human or via AI.

In the example of FIG. 6, the object control unit 104A controls the avatar a4 to cause the avatar a4 to produce the utterance indicated in a speech balloon b4, i.e., ask both of the avatars a5 and a6 a question of “which vegetable do you think you resemble?”. That is, the task an avatar which is subject to the judgment is caused to carry out in FIG. 6 is the task of answering to the above question. In this manner, the object control unit 104A may cause a plurality of avatars to carry out a task at the same time, or may cause the plurality of avatars to individually carry out the task.

To this question, the avatar a5 answers as indicated in a speech balloon b5. The content of this answer is to fail to clearly answer to the question and then ask the question again. Because most users are not considered to have the experience of thinking which vegetable they resemble, such an answer is natural as an answer provided by a human. The judging unit 101A therefore judges, based on the answer (i.e. the result of causing the task to be carried out) provided by the avatar a5 and indicated in the speech balloon b5, that the avatar a5 is acting under control of a human.

To the same question, the avatar a6 answers as indicated in a speech balloon b6. This answer is a clear answer to the question, and the content thereof even includes the reason for the answer and is therefore sufficient. Because most users are not considered to have the experience of thinking which vegetable they resemble, such an answer is unnatural as an answer provided by a human. The judging unit 101A therefore judges, based on the answer (i.e. the result of causing the task to be carried out) provided by the avatar a6 and indicated in the speech balloon b6, that the avatar a6 is acting via AI.

The judging unit 101A can make the judgments as described above by analyzing the text of the answers of the avatars a5 and a6. Further, the characteristic information generating unit 105A may be caused to generate the characteristic information regarding the answers of the avatars a5 and a6. For example, the characteristic information generating unit 105A may generate the characteristic information which is the amount of time from when a question is asked to when an answer is outputted, may generate the characteristic information which is the number of letters of an answer, or may generate the characteristic information which is the ratio between the number of letters of an answer and the amount of time required for the answer to be outputted. In this case, the judging unit 101A uses the generated characteristic information to make the judgments regarding the avatars a5 and a6. As an example, in a case where the amount of time required for an answer to be outputted, which is indicated in the characteristic information, is equal to or greater than a predetermined threshold, the judging unit 101A may judge the avatar to be acting under control of a human, and in a case where the amount of time is smaller than the predetermined threshold, the judging unit 101A may judge the avatar to be acting via AI. As another example, in a case where the number of letters in an answer, which is indicated in the characteristic information, is equal to or greater than a predetermined threshold, the judging unit 101A may judge the avatar to be acting via AI, and in a case where the number of letters is smaller than the predetermined threshold, the judging unit 101A may judge the avatar to be acting under control of a human.

The task an avatar is caused to carry out may be such that it is possible for a human to provide a correct answer in a short time but it is difficult for AI to provide a correct answer. Tasks an avatar may be caused to carry out are, for example, the task of reading a string of numbers and letters which are written in a plurality of fonts and which are partially superimposed on each other and the task of answering an image having a specified subject shown therein, from among a plurality of images. Further, although the object control unit 104A controls the avatar a4 to cause the avatars a5 and a6 to carry out a task in the example of FIG. 6, any method is used to cause the avatars a5 and a6 to carry out a task.

### (Judgment Method 3: Judgment by Authentication)

As described above, the information processing apparatus 1A includes the authenticating unit 103A for performing authentication of a person associated with an avatar. Typically, a user does not cause AI to perform authentication. Thus, the judging unit 101A may judge that an avatar corresponding to a person having been successfully authenticated is acting under control of a human.

Furthermore, typically, a user having undergone authentication often controls an avatar for some time after the authentication. Thus, the judging unit 101A may judge, until a predetermined amount of time elapses after successful authentication of a person, that avatar corresponding to the person is acting under control of a human. This provides an example advantage of making it possible to obtain a valid judgment result through a simple process, in addition to the example advantage provided by the information processing apparatus 1. Furthermore, this judgment method offers another advantage of making it possible to also obtain a valid judgment result regarding an avatar which is not performing an action such as utterance and an avatar the judgment of which is difficult by its action as to whether the avatar is acting under control of a human or via AI.

The authenticating unit 103A may perform, at intervals of a predetermined amount of time, authentication of each of users who are using the metaverse PF. This enables the judging unit 101A to detect an avatar switched from human control to action via AI during the use of the metaverse PF.

### (Judgment Method 4: Another Judgment Method)

As illustrated in FIG. 3, the metaverse PF may include the language model 2 which can be used by a user thereof. In such a case, where a language model which can be used by a user is determined in advance, the judging unit 101A may judge, based on the use status of the language model, whether an avatar is acting under control of a human or via AI.

This provides an example advantage of making it possible to conveniently obtain a valid judgment result. Furthermore, this judgment method offers another advantage of making it possible to also obtain a valid judgment result regarding an avatar which is not performing an action such as utterance and an avatar the judgment of which is difficult by its action as to whether the avatar is acting under control of a human or via AI. Note that the language model which can be used by a user is not limited to the language model 2 included in the metaverse PF. In a case where a user uses a language model included in the metaverse PF, the judging unit 101A may acquire information which indicates the use status of the language model to make the judgment.

Specifically, in a case where a predetermined language model is used at the time of utterance produced by an avatar which is subject to the judgment, the judging unit 101A may judge the avatar to be acting via AI. In a case where a predetermined language model is not used at the time of utterance produced by an avatar which is subject to the judgment, the judging unit 101A may judge the avatar to be acting under control of a human.

The judging unit 101A may make the judgment with use of a judging model having learned, by machine learning, the relationship between the above-described characteristic information generated regarding an avatar which is subject to the judgment and whether the avatar is acting under control of a human or via AI. In this case, the judging unit 101A inputs, to the judging model, the characteristic information generated by the characteristic information generating unit 105A regarding the subject avatar, to judge whether the subject avatar is acting under control of a human or via AI. For example, in a case where the model to be used is a model which outputs a numerical value representing a degree to which the possibility that the subject avatar is acting via AI is high, when the numerical value is equal to or greater than a predetermined threshold, the judging unit 101A may judge that the subject avatar is acting via AI.

In a case where the judging unit 101A uses the judging model as described above to make the judgment, the display control unit 102A may display a numerical value which indicates a degree to which the possibility that an avatar is acting via AI is high (or a degree to which the possibility that the avatar is controlled by a human is high) such that the numerical value is associated with the avatar. Further, the display control unit 102A may cause the display manner of the subject avatar to be in accordance with this numerical value. For example, in a case where an avatar is identified by the outline manner as in EX of FIG. 5, the display control unit 102A may make the outline thinner (make greater the difference from the outline of an avatar which is acting under control of a human) when the degree to which the possibility that the avatar is acting via AI is high is greater. Furthermore, in this case, the display control unit 102A may make the outline thicker (make smaller the difference from the outline of an avatar which is acting under control of a human) when the degree to which the possibility that an avatar is acting under control of a human is greater.

The judging unit 101A may use more than one of the above judgment methods in combination. For example, in a case where a predetermined amount of time has not elapsed since the last successful authentication of an avatar, and it has been judged, based on the characteristic information, that the avatar is acting under control of a human, the judging unit 101A may judge the avatar to be acting under control of a human. In this case, even in a case where it has been judged, based on the characteristic information, that the avatar is acting under control of a human, if the predetermined amount of time has elapsed since the last successful authentication and the avatar has not been further successfully authenticated, the judging unit 101A judges the avatar to be acting via AI.

### (Flow of Processes)

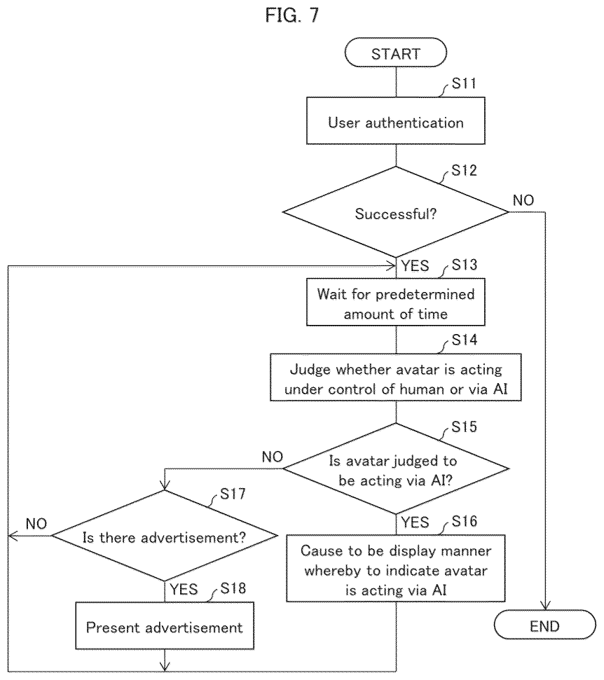

A flow of processes carried out by the information processing apparatus 1A will be described below on the basis of FIG. 7. FIG. 7 is a flowchart illustrating a flow of processes carried out by the information processing apparatus 1A. The flow illustrated in FIG. 7 includes the processes which constitute the display control method in accordance with the present example embodiment.

In S11, the authenticating unit 103A performs authentication of a user (hereinafter, referred to as a target user) who seeks to start using the metaverse PF. In S12, the authenticating unit 103A judges whether the authentication of S11 is successful. In a case of NO judgment in S12, i.e. failure of the authentication, the processing of FIG. 7 ends. On the other hand, in a case of YES judgment in S12, i.e. success in the authentication, the avatar of the target user is displayed in the virtual space SP. This enables the target user to cause the avatar to act in the virtual space SP. In this situation, the display manner of the avatar is the display manner used when an avatar is controlled by a person. Thereafter, the processing continues to S13.

In S13, the judging unit 101A waits for a predetermined amount of time, and after the predetermined amount of time elapses, proceeds to the process of S14. Waiting for a predetermined period of time in S13 allows the judging process of S14, which will be described below, to be repeated at intervals of the predetermined amount of time. The predetermined amount of time can be set as appropriate. For example, in a case where it is desirable that switching the control of an avatar to AI should be reflected in the display as soon as possible, the predetermined amount of time may be set to be as short as one minute. Note that the judging process of S14 does not need to necessarily be repeated at intervals of predetermined amount of time. For example, when an action (e.g. utterance) performed by an avatar is repeated a predetermined number of times, the judging process of S14 may be triggered by this repetition, to be carried out. In this case, the process of S13 is omitted.

In S14 (judging process), the judging unit 101A judges whether the avatar of the target user is acting under control of a human or via AI. As described above, various methods can be used as the method for judging whether the avatar of the target user is acting under control of a human or via AI. For example, in a case where the characteristic information is used for the judgment, the characteristic information generating unit 105A generates the characteristic information which indicates a characteristic of the action of the avatar performed in the above predetermined period of time, and the judging unit 101A uses the generated characteristic information to make the judgment.

In making the judgment in S14, the avatar of the target user may be caused to carry out a predetermined task. In this case, the object control unit 104A may control another avatar which is not the avatar of the target user, to encourage, through the other avatar, the avatar of the target user to carry out the predetermined task. Also in this case, the characteristic information generating unit 105A may generate the characteristic information which indicates a characteristic of the action of the avatar performed when the avatar carries out the predetermined task. By using this characteristic information, it is possible for the judging unit 101A to make the judgment based on the result of causing a task to be carried out.

In making the judgment of S14, authentication of the target user may be performed. In this case, the authenticating unit 103A requests the target user to undergo further authentication. In a case where the further authentication is successful, the judging unit 101A judges the avatar of the target user to be controlled by a human (specifically, the target user), and in a case where the further authentication fails, the judging unit 101A judges the avatar of the target user to be acting via AI.

In S15, the display control unit 102A checks whether the avatar is judged in S14 to be acting via AI. In a case of YES judgment in S15, the processing continues to S16. In S16 (display control process), the display control unit 102A sets the display manner of the avatar of the target user to the display manner whereby to indicate that the avatar is acting via AI. This causes the display manner of the avatar to be in accordance with the judgment result obtained in the judging process of S14. Upon the completion of the process of S16, the processing returns to S13.

In a case of NO judgment in S15, the display control unit 102A does not change the display manner of the avatar of the target user. In this case, the display manner of the avatar of the target user is maintained as the display manner used when an avatar is controlled by a human. Thereafter, the processing continues to S17.

In S17, the information presenting unit 106A judges whether there is an advertisement to be presented to the target user. In a case of NO judgment in S17, the processing returns to S13, and in a case of YES judgment in S17, the processing continues to S18. In S18, the information presenting unit 106A presents an advertisement to the target user. Upon the completion of the process of S18, the processing returns to S13. Note that as described above, the information to be presented to the target user is not limited to an advertisement.

### (Example Judgment in Chat)

As above, the information processing apparatus 1A is capable of causing the display manner of an avatar displayed in the virtual space SP to be in accordance with the result of the judgment on whether the avatar is acting under control of a human or via AI. Further, as described above, the “avatar” in the above description is interchangeable with any “object”.

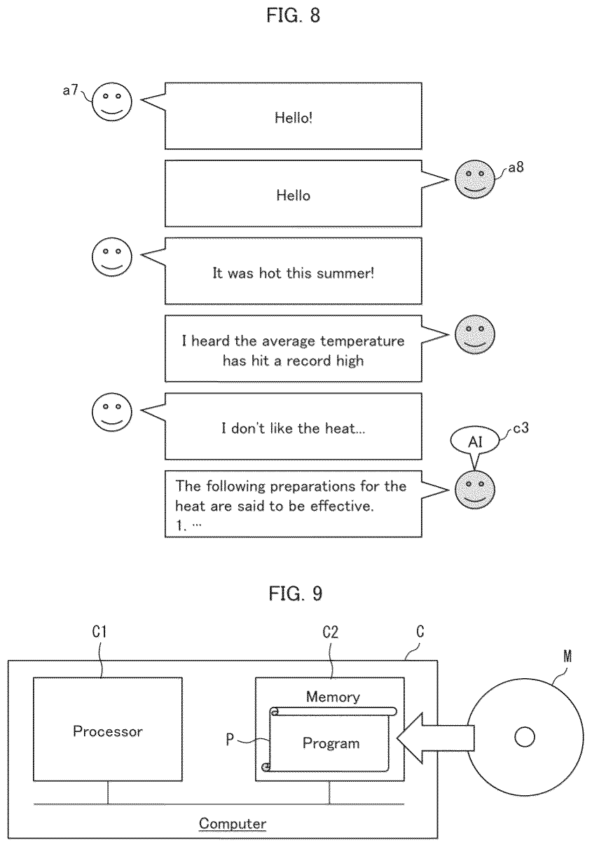

Here is a description of an example “object”, which is not the “avatar”, based on FIG. 8. FIG. 8 is a representation of an example in which the information processing apparatus 1A is applied to chat screen display. More specifically, illustrated in FIG. 8 is the example in which the display manner of an icon displayed in a chat screen is caused to be in accordance with the result of the judgment on whether utterance produced by the icon serving as the agent of the utterance is performed under control of a human or via AI.

In the chat screen illustrated in FIG. 8, icons a7 and a8 are displayed as the agents of the utterance. Text displayed in the speech balloon associated with the icon a7 is an utterance produced by the icon a7, and text displayed in the speech balloon associated with the icon a8 is an utterance produced by the icon a8. The utterances produced by the icons a7 and a8 are displayed so as to be arranged in chronological order.

The icon a7 is the icon of a user having a chat. The icon a8 is the icon of the other end of the chat of the user. The user is chatting without knowing whether the other end of the chat is a human or AI.

The judging unit 101A of the information processing apparatus 1A is capable of judging whether the icon a8 is uttering under control of a human or via AI in the conversation made in such a chat screen. To this judgment, methods the same as the above judgment methods used in a case of an avatar can be applied. For example, the characteristic information generating unit 105A may generate characteristic information which indicates at least one selected from the group consisting of the content of utterance produced by the icon a8, a response time to utterance produced by the icon a7 (the user), and the number of letters of text of utterance. The judging unit 101A may then use the generated characteristic information to judge whether the icon a8 is uttering under control of a human or via AI.

In a case of chats, as the conversation goes on, the utterances of the icon a8, which serve as materials for the judgment, increase. Thus, the judging unit 101A may make a further judgment once every predetermined number of utterances produced by the icon a8. In the example of FIG. 8, on the basis of the third utterance produced by the icon a8, utterance produced by the icon a8 is judged to be produced via AI. On the basis of this judgment, the display control unit 102A displays judgment result information c3, which indicates the judgment result suggesting that the third utterance is produced via AI, such that the judgment result information c3 is associated with the icon a8 which produces the third utterance.

As another example, for a user using an online service of providing advice on healthcare in a chat format, whether the advice is provided by a human or AI is a matter of interest. In such a case, by using the information processing apparatus 1A, it is possible to make identifiable whether the advice is provided by a human or AI. This enables the user to take into consideration whether the advice is provided by AI or a human, to judge, for example, whether to follow the advice.

Also in occasions other than a chat which include, for example, a game played by operating a character, the information processing apparatus 1A is capable of judging whether the character is operated by a human or AI and causing the display manner of the character to be in accordance with the result of the judgment.

### [Variation]

The agent of each of the processes described in the above example embodiments is any performer, and is not limited to the above examples. That is, the functions of the information processing apparatuses 1 and 1A can be implemented by a plurality of apparatuses (which can also be referred to as processors) capable of communicating with each other. For example, the processes described in the flowcharts of FIGS. 2 and 7 can be shared and carried out by the plurality of processors. That is, the display control method of each of the above example embodiments may be carried out by a single processor, or may be carried out by a plurality of processors. For example, the process (judging process) of S14 and the process (display control process) of S16 of FIG. 7 may be carried out by a processor of the information processing apparatus 1A and a processor of the terminal 3, respectively.

### [Software Implementation Example]

Some or all of the functions of the information processing apparatuses 1 and 1A may be implemented by hardware such as an integrated circuit (IC chip), or may be implemented by software.

In the latter case, the information processing apparatuses 1 and 1A are each provided by, for example, a computer which executes the instructions of a program which is software that implements the functions. An example (hereinafter, computer C) of such a computer is illustrated in FIG. 9 FIG. 9 is a block diagram illustrating a hardware configuration of the computer C which functions as the information processing apparatuses 1 and 1A.

The computer C includes at least one processor C1 and at least one memory C2. The memory C2 has recorded thereon a program (display control program) P for causing the computer C to operate as the information processing apparatus 1 or 1A. In the computer C, the processor C1 retrieves the program P from the memory C2 to execute the program P, so that the functions of the information processing apparatus 1 or 1A are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display, or a printer is connected.

The program P can be recorded on a non-transitory tangible recording medium M capable of being read by the computer C. Examples of such a recording medium M can include a tape, a disk, a card, a semiconductor memory, and a programmable logic circuit. The computer C can obtain the program P via such a recording medium M. The program P can be transmitted via a transmission medium. Examples of such a transmission medium can include a communication network and a broadcast wave. The computer C can also obtain the program P via such a transmission medium.

### [Additional Remark 1]

The whole or part of the example embodiments disclosed above can be described as, but not limited to, the following supplementary notes.

### (Supplementary Note A1)

An information processing apparatus, including: a judging means for judging whether an object displayed as an agent of action is acting under control of a human or via artificial intelligence; and a display control means for causing a display manner of the object to be in accordance with a result of the judgment made by the judging means.

### (Supplementary Note A2)

The information processing apparatus described in supplementary note A1, in which the judging means is configured to use characteristic information which indicates a characteristic of an action of the object, to judge whether the object is acting under control of a human or via artificial intelligence.

### (Supplementary Note A3)

The information processing apparatus described in supplementary note A2, in which the characteristic information indicates an amount of time from when an action for asking the object to utter is performed to when the object starts uttering.

### (Supplementary Note A4)

The information processing apparatus described in any one of supplementary notes A1 to A3, further including an object control means for causing the object to carry out a predetermined task, the judging means being configured to judge, based on a result of causing the task to be carried out, whether the object is acting under control of a human or via artificial intelligence.

### (Supplementary Note A5)

The information processing apparatus described in any one of supplementary notes A1 to A4, further including an authenticating means for performing authentication of a person associated with the object, the judging means being configured to judge, until a predetermined amount of time elapses after a person is successfully authenticated, that the object corresponding to the person successfully authenticated is acting under control of a human.

### (Supplementary Note A6)

The information processing apparatus described in any one of supplementary notes A1 to A5, further including an information presenting means for presenting predetermined information to the object judged, by the judging means, to be acting under control of a human.

### (Supplementary Note B1)

A display control method, including: at least one processor judging whether an object displayed as an agent of action is acting under control of a human or via artificial intelligence; and the at least one processor causing a display manner of the object to be in accordance with a judgment result obtained in the judging.

### (Supplementary Note B2)

The display control method described in supplementary note B1, in which in the judging, the at least one processor uses characteristic information which indicates a characteristic of an action of the object, to judge whether the object is acting under control of a human or via artificial intelligence.

### (Supplementary Note B3)

The display control method described in supplementary note B2, in which the characteristic information indicates an amount of time from when an action for asking the object to utter is performed to when the object starts uttering.

### (Supplementary Note B4)

The display control method described in any one of supplementary notes B1 to B3, in which the display control method further includes the at least one processor causing the object to carry out a predetermined task, and in the judging, the at least one processor judges, based on a result of causing the predetermined task to be carried out, whether the object is acting under control of a human or via artificial intelligence.

### (Supplementary Note B5)

The display control method described in any one of supplementary notes B1 to B4, in which the display control method further includes the at least one processor performing authentication of a person associated with the object, and in the judging, the at least one processor judges, until a predetermined amount of time elapses after a person is successfully authenticated, that the object corresponding to the person successfully authenticated is acting under control of a human.

### (Supplementary Note B6)

The display control method described in any one of supplementary notes B1 to B5, further including the at least one processor presenting predetermined information to the object judged, in the judging, to be acting under control of a human.

### (Supplementary Note C1)

A display control program for causing a computer to function as: a judging means for judging whether an object displayed as an agent of action is acting under control of a human or via artificial intelligence; and a display control means for causing a display manner of the object to be in accordance with a result of the judgment made by the judging means.

### (Supplementary Note C2)

The display control program described in supplementary note C1, in which the judging means is configured to use characteristic information which indicates a characteristic of an action of the object, to judge whether the object is acting under control of a human or via artificial intelligence.

### (Supplementary Note C3)

The display control program described in supplementary note C2, in which the characteristic information indicates an amount of time from when an action for asking the object to utter is performed to when the object starts uttering.

### (Supplementary Note C4)

The display control program described in any one of supplementary notes C1 to C3, in which the display control program further causes the computer to function as an object control means for causing the object to carry out a predetermined task, and the judging means is configured to judge, based on a result of causing the task to be carried out, whether the object is acting under control of a human or via artificial intelligence.

### (Supplementary Note C5)

The display control program described in any one of supplementary notes C1 to C4, in which the display control program further causes the computer to function as an authenticating means for performing authentication of a person associated with the object, and the judging means is configured to judge, until a predetermined amount of time elapses after a person is successfully authenticated, that the object corresponding to the person successfully authenticated is acting under control of a human.

### (Supplementary Note C6)

The display control program described in any one of supplementary notes C1 to C5, in which the display control program further causes the computer to function as an information presenting means for presenting predetermined information to the object judged, by the judging means, to be acting under control of a human.

### (Supplementary Note D1)

An information processing apparatus, including at least one processor, the at least one processor carrying out: a judging process of judging whether an object displayed as an agent of action is acting under control of a human or via artificial intelligence; and a display control process of causing a display manner of the object to be in accordance with a judgment result obtained by the judging process.

### (Supplementary Note D2)

The information processing apparatus described in supplementary note D1, in which in the judging process, the at least one processor uses characteristic information which indicates a characteristic of an action of the object, to judge whether the object is acting under control of a human or via artificial intelligence.

### (Supplementary Note D3)

The information processing apparatus described in supplementary note D2, in which the characteristic information indicates an amount of time from when an action for asking the object to utter is performed to when the object starts uttering.

### (Supplementary Note D4)

The information processing apparatus described in any one of supplementary notes D1 to D3, in which the at least one processor further carries out an object control process of causing the object to carry out a predetermined task, and in the judging process, the at least one processor judges, based on a result of causing the task to be carried out, whether the object is acting under control of a human or via artificial intelligence.

### (Supplementary Note D5)

The information processing apparatus described in any one of supplementary notes supplementary notes D1 to D4, in which the at least one processor further carries out an authenticating process of performing authentication of a person associated with the object, and in the judging process, the at least one processor judges, until a predetermined amount of time elapses after a person is successfully authenticated, that the object corresponding to the person successfully authenticated is acting under control of a human.

### (Supplementary Note D6)

The information processing apparatus described in any one of supplementary notes D1 to D5, in which the at least one processor further carries out an information presenting process of presenting predetermined information to the object judged, in the judging process, to be acting under control of a human.

### (Supplementary Note E1)

A computer-readable non-transitory recording medium having recorded thereon a display control program for causing a computer to carry out: a judging process of judging whether an object displayed as an agent of action is acting under control of a human or via artificial intelligence; and a display control process of causing a display manner of the object to be in accordance with a judgment result obtained in the judging process.

### REFERENCE SIGNS LIST

1: Information processing apparatus
101: Judging unit (judging means)
102: Display control unit (display control means)
1A: Information processing apparatus
101A: Judging unit (judging means)
102A: Display control unit (display control means)
103A: Authenticating unit (authenticating means)
104A: Object control unit (object control means)
106A: Information presenting unit (information presenting means)

1. An information processing apparatus, comprising at least one processor, the at least one processor carrying out:
a judging process of judging whether an object displayed as an agent of action is acting under control of a human or via artificial intelligence; and
a display control process of causing a display manner of the object to be in accordance with a judgment result obtained in the judging process.

2. The information processing apparatus according to claim 1, wherein in the judging process, the at least one processor uses characteristic information which indicates a characteristic of an action of the object, to judge whether the object is acting under control of a human or via artificial intelligence.

3. The information processing apparatus according to claim 2, wherein the characteristic information indicates an amount of time from when an action for asking the object to utter is performed to when the object starts uttering.

4. The information processing apparatus according to claim 1, wherein the at least one processor further carries out an object control process of causing the object to carry out a predetermined task, and
in the judging process, the at least one processor judges, based on a result of causing the task to be carried out, whether the object is acting under control of a human or via artificial intelligence.

5. The information processing apparatus according to claim 1, wherein the at least one processor further carries out an authenticating process of performing authentication of a person associated with the object, and
in the judging process, the at least one processor judges, until a predetermined amount of time elapses after a person is successfully authenticated, that the object corresponding to the person successfully authenticated is acting under control of a human.

6. The information processing apparatus according to claim 1, wherein the at least one processor further carries out an information presenting process of presenting predetermined information to the object judged, in the judging process, to be acting under control of a human.

7. A display control method, comprising:
at least one processor judging whether an object displayed as an agent of action is acting under control of a human or via artificial intelligence; and
the at least one processor causing a display manner of the object to be in accordance with a judgment result obtained in the judging.

8. A computer-readable non-transitory recording medium having recorded thereon a display control program for causing a computer to carry out:
a judging process of judging whether an object displayed as an agent of action is acting under control of a human or via artificial intelligence; and
a display control process of causing a display manner of the object to be in accordance with a judgment result obtained in the judging process.
